(19) United States
(12) Patent Application Publication
(10) Pub. No.: US 2009/0125705 A1
(43) Pub. Date: May 14, 2009

(54) DATA PROCESSING METHOD AND APPARATUS WITH RESPECT TO SCALABILITY OF PARALLEL COMPUTER SYSTEMS

(75) Inventor: Shigeo ORII, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/354,449

(22) Filed: Jan. 15, 2009

Related U.S. Application Data
(63) Continuation of application No. PCT/JP2006/314469, filed on Jul. 21, 2006.

(51) Int. Cl. G06F 9/30

(52) U.S. Cl. 712/220; 712/E09.016

(57) ABSTRACT

A data processing method for scalability of a parallel computer system includes: obtaining a processing time τ(p) that is the longest processing time in a case where a parallel processing is carried out by p processors and a processing time γᵢ(p) (i represents a processor number) that is a processing time of parallel calculation portions during an executed processing; calculating a limit processing time τ_{LT}(p) that is an entire processing time in assuming that the processing time of the parallel calculation portions has become zero, by using the processing time τ(p) and the processing time γᵢ(p) of the parallel calculation portions; and outputting a relation between the processing τ(p) and the limit processing time τ_{LT}(p) with respect to the number p of processors to an output device. Favorably, the limit processing time τ_{LT}(p) becomes constant without depending on the processing time τ(p), and it is possible to evaluate the scalability by judging the difference with the favorable state.

### CROSS-REFERENCE TO RELATED APPLICATIONS

This application is a continuing application, filed under 35 U.S.C. section 111(a), of International Application PCT/JP2006/314469, filed Jul. 21, 2006.

### FIELD

This invention relates to a data processing technique concerning the scalability of a parallel computer system.

### BACKGROUND

In the parallel processing, it is desired that the performance is enhanced with the increase of the number p of processors, and when this is realized, it is represented that there is the scalability. On the other hand, when this is not realized, it is represented that there is no scalability. In a case of discussing the scalability, there is a method, as depicted in FIG. 1, of judging based on a relation between the number p of processors and a parallel processing time τ(p), and a method, as depicted in FIG. 2, of judging based on a relation between the number p of processors and a ratio (i.e. an acceleration ratio Ap=τ(1)/τ(p)) of the parallel processing time τ(1) in a case of one processor to a processing time τ(p). Incidentally, the parallel processing time τ(p) is represented as follows. τᵢ(p) is a processing time of a processor i.

$$τ ( p ) = {{Max}^{p}}_{i = 1} ( {τ}_{i} ( p ) ) \qquad ( 1 )$$

In the case of FIG. 1, when the parallel processing time τ(p) decreases with the number of processors, it is said that the scalability exists. In addition, in the case of FIG. 2, when the acceleration ratio Ap increases with the number p of processors (ideally, when it increases along a 45-degree line passing through the origin), it is said that the scalability exists. However, in a normal case, along with the increase of the number p of processors, the decrease of the parallel processing time τ(p) becomes gradual, and the increase of the ratio becomes gradually saturated. Therefore, the range that the scalability exists in the curves in FIGS. 1 and 2 depends on a person who judges it, and its judgment threshold is very vague. As for these matters, see Sekiguchi Satoshi et al., “A Metrical Approach for Measuring the Scalability of Parallel Systems”, Joint Symposium on Parallel Processing JSPP '96, pp. 235-242, June 1996. In addition, because τ(1) is required in the case of FIG. 2, it is impossible to evaluate the scalability when τ(1) cannot be measured.

### SUMMARY

In addition, as the improvement of the conventional arts, it is possible to defines a limit acceleration ratio A_{LT}(p) as follows and represent a relation with the number p of processors as depicted in FIG. 3. Incidentally, the limit acceleration ratio A_{LT}(p) is a limit scale factor in a case where it is assumed that the processing time of parallel calculation portions becomes “0”, and by using this, the potential of the scalability can be evaluated, quantitatively. Namely, this can represent how much further faster you can ideally make the parallel computer system calculate.

$$\begin{matrix}{A}_{LT} ( p ) = \frac{1}{1 - {ɛ}_{p} ( p )} \\ {ɛ}_{p} ( p ) = \frac{{\sum }_{i = 1}^{p} {γ}_{i} ( p )}{p τ ( p )}\end{matrix}$$

Here, εₚ(p) is called a parallel efficiency metric.

In view of FIG. 3, when the calculation size is n=800 in a certain parallel computer system, it is understood that the calculation speed of the system ideally becomes about 1.5 times as fast as the present speed in a case of p=10. In addition, when the calculation size is n=7200, it is understood that the calculation speed of the system ideally becomes about twice as fast as the present speed in a case of p=10. Furthermore, when the calculation size is n=51200, it is understood that the calculation speed of the system ideally becomes about 2.5 times as fast as the present speed in a case of p=10.

Moreover, it is possible to define a limit processing time τ_{LT}(p) as follows and represent a relation with the number p of processors as depicted in FIG. 4. The limit processing time τ_{LT}(p) is a processing time in a case where it is assumed that the processing time of the parallel processing portions has become “0”.

$${τ}_{LP} ( p ) = \frac{τ ( p )}{{A}_{LT} ( p )} \qquad ( 2 )$$

Although the difference of the processing times according to the calculation size cannot be clarified by the limit acceleration ratio A_{LT}(p) used in FIG. 3, it becomes possible to carry out the evaluation paying attention to the calculation size by using the limit processing time τ_{LT}(p). Namely, the processing time for the calculation size n=51200 is 100 times or more as long as the processing time for the calculation scale n=800, and an amount of used memory and a utilization method of the cache must be different. It becomes possible to evaluate such problems by considering the relation between the limit processing time τ_{LT}(p) and the number p of processors as depicted in FIG. 4.

However, the scalability evaluation by using graphs as depicted in FIGS. 3 and 4 has a problem that it is impossible to clearly designate the range the scalability exists.

Then, an object of this invention is to provide a new technique to quantitatively carry out the scalability evaluation.

In addition, another object of this invention is to provide a technique to present a limit point of the scalability.

Furthermore, still another object of this invention is to provide a technique to carry out scalability comparison with respect to plural parallel computer systems.

A data processing method for scalability of a parallel computer system includes: obtaining a processing time τ(p) that is the longest processing time in a case where a parallel processing is carried out by p processors and a processing time γᵢ(p) (i represents a processor number) that is a processing time of parallel calculation portions during an executed processing; calculating a limit processing time τ_{LT}(p) that is an entire processing time in assuming that the processing time of the parallel calculation portions has become zero, by using the processing time τ(p) and the processing time γᵢ(p) of the parallel calculation portions; and outputting a relation between the processing time τ(p) and the limit processing time τ_{LT}(p) with respect to the number p of processors to an output device.

Thus, when the relation between the processing time τ(p) and the limit processing time τ_{LT}(p) is considered, the limit processing time τ_{LT}(p) favorably becomes constant without depending on the processing time τ(p). Namely, it becomes possible to easily judge the difference with the favorable state. Incidentally, because it does not depend on whether or not τ(1) could be measured, the scalability can be evaluated in a case where τ(1) cannot be measured.

Moreover, the aforementioned outputting may include generating a graph in a space mapped by an axis of the processing time τ(p) and an axis of the limit processing time τ_{LT}(p), and outputting the generated graph. By doing so, it becomes possible to visually understand how the relation changes along with the change of the number p of processors and further visually grasp an ideal value.

Furthermore, the aforementioned outputting may include identifying, as a limit point, the number p of processors in a case where a ratio of a variation of the limit processing time τ_{LT}(p) to a variation of the processing time τ(p) changes from negative to positive along with increase of the number p of processors, and outputting the identified number p of processors. Normally, when the number p of processors is small, it is in a state the scalability exists, and when the number p of processors increases, the scalability gradually disappears. In the state the scalability exists, the limit processing time τ_{LT}(p) increases along with the decrease of the processing time τ(p), namely, the slope is negative, and ideally, the slope (i.e. ratio) is zero. Accordingly, after the slope changes to positive, it can be judged that the scalability does not exist. Incidentally, there is a case where the change from negative to positive is judged taking into consideration the measurement errors and so on.

Moreover, the aforementioned identifying may include identifying, as the limit point, the number p of processors immediately before the ratio changes from negative to positive. It is possible to easily judge the limit point of the scalability. Incidentally, there is a case where the change from negative to positive is judged taking into account the measurement errors and so on.

Furthermore, the data processing method may further include: carrying out the obtaining, the calculating and the outputting for a second parallel computer system; identifying the first limit processing time τ_{LT1}(p) in the parallel computer system and the second limit processing time τ_{LT2}(p) in the second parallel computer system, whose corresponding processing times τ(p) are identical each other in the parallel computer system and the second parallel computer system; and calculating a second ratio of the first limit processing time τ_{LT1}(p) and the second limit processing time τ_{LT2}(p), and outputting the second ratio to the output device. In the state the scalability exists, it becomes possible to quantitatively compare the computer systems. Incidentally, the scalability of the parallel computer system whose limit processing time τ_{LT}(p) is longer is worse.

Furthermore, the calculating the limit processing time may include: identifying a processing time γⱼ(p) of the parallel calculation portions of a processor j that required the processing time τ(p); and identifying, as the limit processing time τ_{LT}(p), the difference between the processing time τ(p) and the processing time γⱼ(p) of the parallel calculation portions. When the load is balanced, it is possible to evaluate the computer system by using such a simple method.

In addition, the aforementioned calculating the limit processing time may include: calculating an average of the processing times γᵢ(p) of the parallel calculation portions; and identifying, as the limit processing time τ_{LT}(p), the difference between the processing time τ(p) and the average of the processing times γᵢ(p) of the parallel calculation portions. According to such a calculation method, even when the load is not balanced, it is possible to accurately calculate the limit processing time τ_{LT}(p).

Furthermore, the data processing method may further include measuring, in the parallel computer system, the processing time γᵢ(p) of the parallel calculation portions and the processing time τᵢ(p) in each processor, and storing the processing time γᵢ(p) and the processing time τᵢ(p) into a storage device of the parallel computer system.

It is possible to create a program causing a computer to execute the aforementioned data processing method, and such a program is stored into a computer-readable storage medium or storage device such as a flexible disc, CD-ROM, magneto-optical disk, semiconductor memory and hard disk. Incidentally, the intermediate processing result is temporarily stored into a storage device such as a memory.

### BRIEF DESCRIPTION OF DRAWINGS

FIG. 1 is a diagram representing a graph relating to a first conventional technique;

FIG. 2 is a diagram representing a graph relating to a second conventional technique;

FIG. 3 is a diagram representing a graph relating to a first improved example;

FIG. 4 is a diagram representing a graph relating to a second improved example;

FIG. 5 is a system outline diagram relating to one embodiment of this invention;

FIG. 6 is a diagram to explain an outline of measurement by sampling;

FIG. 7 is a diagram depicting a main processing relating to the embodiment of this invention;

FIG. 8 is a diagram depicting an example of data stored in a scalability limit point judgment data storage;

FIG. 9 is a diagram depicting an example of a scalability evaluation graph;

FIG. 10 is a diagram depicting a processing flow of a scalability limit point identifying processing;

FIG. 11 is a diagram depicting another example of data stored in the scalability limit point judgment data storage; and

FIG. 12 is a diagram depicting another example of the scalability evaluation graph.

### DESCRIPTION OF EMBODIMENTS

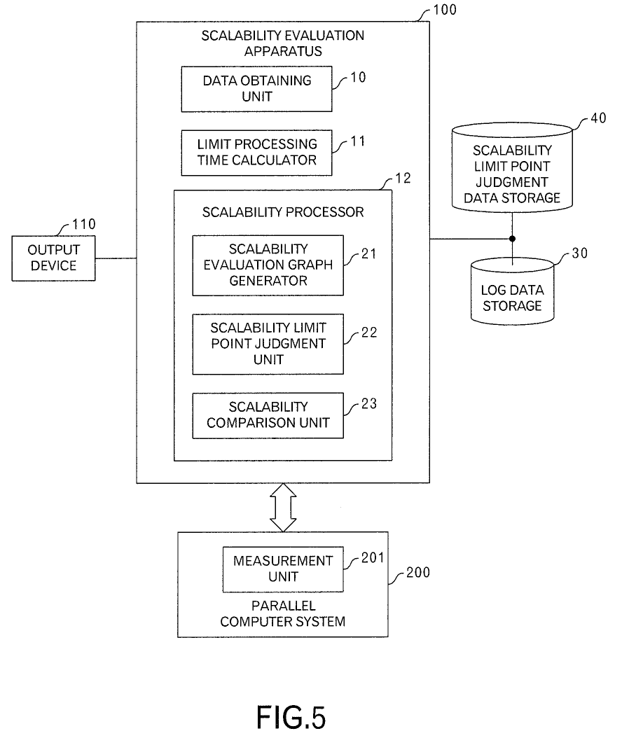

FIG. 5 depicts a system outline relating to one embodiment of this invention. A scalability evaluation apparatus 100 is a computer with a single processor for evaluating the scalability of a parallel computer system 200, and is connected to an output device 110 such as a printer or a display device. However, the scalability evaluation apparatus 100 may be a parallel computer. The scalability evaluation apparatus 100 includes a data obtaining unit 10, a limit processing time calculator 11 and a scalability processor 12. The scalability processor 12 has a scalability evaluation graph generator 21, a scalability limit point judgment unit 22 and a scalability comparison unit 23. The scalability evaluation apparatus 100 is connected to a log data storage 30 and a scalability limit point judgment data storage 40. The parallel computer system 200 includes a measurement unit 201. For example, the scalability evaluation apparatus 100 is connected to the parallel computer system 200 through a network. When the comparison of the parallel computer systems 200 is carried out, plural parallel computer systems 200 exist. In addition, the parallel computer system 200 can execute the same processing while changing the number p of processors.

The measurement unit 201 of the parallel computer system 200 measures a parallel processing time γᵢ(p) of each processor i in a case of the number p of processors and a processing time τᵢ(p) of each processor i, while executing a parallel processing in accordance with a program. Incidentally, a processing time χ_{i,j}(p) of each parallel performance impediment factor j may be measured. For example, a time from a start to an end of each processing is measured by a timer, or a start time and an end time of each processing are recorded to compute a processing time by using them after the end of the processing. The measurement of the time may be performed by the software including the operating system (OS) or hardware. Data concerning the measured processing times is temporarily stored into a memory of the parallel computer system 200, and may be stored into other storage devices such as a hard disk, according to circumstances.

Moreover, there is also a case where, instead of the measurement of the processing times, events of a program being executed are confirmed at predetermined time intervals, and the respective events are counted. Such a measurement is called a measurement by sampling. Although there is a difference due to the measurement accuracy, the method by the time measurement and the method by the sampling have the same result.

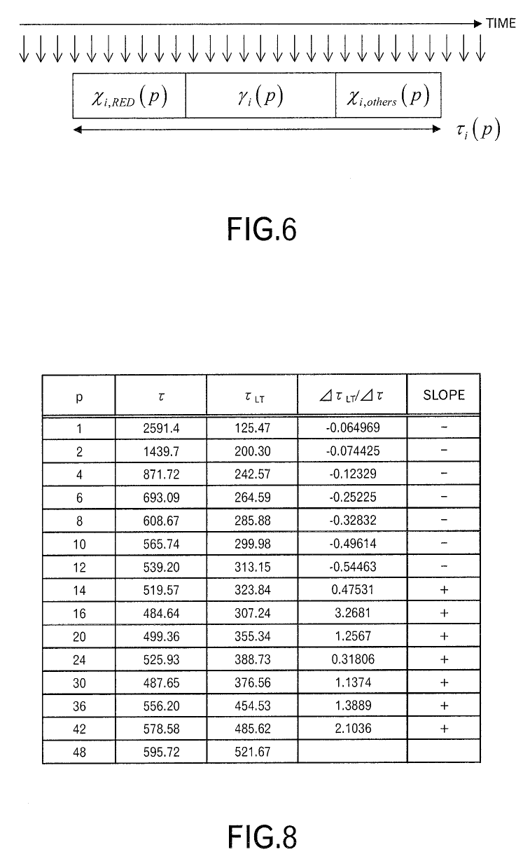

FIG. 6 depicts a conceptual view of the measurement by the sampling. FIG. 6 depicts a manner that a time passes from the left to the right. In FIG. 6, a downward arrow indicates a timing of the sampling, and the sampling is carried out at predetermined time intervals as indicated by the intervals between the downward arrows. Moreover, in FIG. 6, after a redundancy processing is first executed for χ_{i,RED}(p), a parallel calculation is carried out for γᵢ(p). Incidentally, the processing is executed for τᵢ(p) as a whole. The number of times of the sampling is seven in the event of the redundancy processing continuing for χ_{i,RED}(p), and nine in the event of the parallel calculation continuing for γᵢ(p). During the entire processing time τᵢ(p), the number of times of the sampling is 22. Events other than the intentionally measured χ_{i,RED}(p) among the parallel performance impediment factors are collectively expressed by χ_{i,others}(p), and it is understood that the number of times of the sampling during χ_{i,others}(p) is 6 (=22−9−7), by using the intentionally measured τᵢ(p), γᵢ(p) and χ_{i,RED}(p). Incidentally, as described above, the processing time χ_{i,j}(p) of the parallel performance impediment factor j is not always measured. However, because the general measurement by the sampling is described in the following, the measurement of the processing time χ_{i,j}(p) of the parallel performance impediment factor j is also described.

The summary of how to carry out the measurement actually by the sampling will be described below.

(1) Portion of τᵢ(p)

(a) A flag for an event τᵢ(p) is turned ON at a start of a processing, and is turned OFF at an end of the processing. At the time of execution, it is identified at predetermined time intervals whether the flag for the event τᵢ(p) is ON/OFF, and the number of times that it is identified that the flag is ON is counted to obtain the number of times of the sampling.

A description and a processing in the following methods are combined as the need arises to measure the processing time.
A programmer detects a start and an end of a processing in a program, that is, a position where the flag is to be turned ON/OFF, and gives a description for turning the flag ON/OFF.
In the case where a parallel language extension, a complier directive or the like is used, a tool interprets the parallel language extension, the complier directive or the like, and gives a description for turning the flag ON/OFF.
In the case where a parallel language extension, a complier directive or the like is used, a complier interprets the parallel language extension, the complier directive or the like, and gives a description for turning the flag ON/OFF.
A complier detects a start and an end of a processing in a program, that is, a position where the flag is to be turned ON/OFF, and gives a description for turning the flag ON/OFF.
An OS detects a start and an end of a processing in a program, that is, a position where the flag is to be turned ON/OFF, and gives a description for turning the flag ON/OFF.
A runtime library detects a start and an end of a processing in a program, that is, a position where the flag is to be turned ON/OFF, and gives a description for turning the flag ON/OFF.
Hardware detects a start and an end of a processing in a program, that is, a position where the flag is to be turned ON/OFF, and gives a description for turning the flag ON/OFF.
A description for a processing of discriminating that the flag is ON and counting the number of times is given at a complier level.
A description for a processing of discriminating that the flag is ON and counting the number of times is given at an OS level.
A description for a processing of discriminating that the flag is ON and counting the number of times is given at a runtime library level.
A description for a processing of discriminating that the flag is ON and counting the number of times is given at a hardware level.
A description for a processing of discriminating that the flag is ON and counting the number of times is given at a tool level.
A description for a processing of discriminating that the flag is ON and counting the number of times is given at a program level.
A processing of discriminating that the flag is ON and counting the number of times is executed at a hardware level.

(b) An event is specified by a program name or an execution module name substituting for that, and at the time of execution, the program name or the execution module name is discriminated at predetermined time intervals, and the number of times that the name is discriminated is counted to obtain the number of times of the sampling.

A name creation method in the following methods, a discrimination processing and a count processing are combined as the need arises to measure the processing time.
A complier creates the program name or the execution module name.
An OS creates the program name or the execution module name.
A runtime library creates the program name or the execution module name.
Hardware creates the program name or the execution module name.
The program name or the execution module name is created by a description of a parallel language extension or a complier directive.
The program name or the execution module name is created by a description of a programmer.
A description for a discrimination processing of the created program name or execution module name and a count processing is given at a complier level.
A description for a discrimination processing of the created program name or execution module name and a count processing is given at an OS level.
A description for a discrimination processing of the created program name or execution module name and a count processing is given at a runtime library level.
A discrimination processing of the created program name or execution module name and a count processing is executed at hardware level.
A description for a discrimination processing of the created program name or execution module name and a count processing is given at a tool level.
A description for a discrimination processing of the created program name or execution module name and a count processing is given at a program level.
A discrimination processing of the created program name, execution module name or the like and a count processing are executed at a hardware level.
   (2) Portion of χ_{i,j}(p) and γᵢ(p)

(a) Each time an event χ_{i,j}(p) or γᵢ(p) appears, a flag for that is turned ON at the start of the processing, and the flag for that is set OFF at the end of the processing.

It is assumed that at the time of execution, it is discriminated at predetermined time intervals whether a flag for each event is ON/OFF, and the number of times that it is discriminated that the flag is ON is counted to obtain the number of times of the sampling. Since there is a case where the events χ_{i,j}(p) and γᵢ(p) cannot be detected by one method, a description and a processing in the following methods are combined as the need arises to measure the processing time.
A programmer detects the start and the end of a processing in a program, that is, a position where the flag is to be turned ON/OFF, and gives a description for turning the flag ON/OFF.
In the case where a parallel language extension, a complier directive or the like is used, a tool interprets the parallel language extension, the complier directive or the like, and gives a description for turning the flag ON/OFF.
In the case where a parallel language extension, a complier directive or the like is used, a complier interprets the parallel language extension, the complier directive or the like, and gives a description for turning the flag ON/OFF.
The complier detects a start and an end of a processing in a program, that is, a position where the flag is to be turned ON/OFF, and gives a description for turning the flag ON/OFF.
An OS detects a start and an end of a processing in a program, that is, a position where the flag is to be turned ON/OFF, and gives a description for turning the flag ON/OFF.
A runtime library detects a start and an end of a processing in a program, that is, a position where the flag is to be turned ON/OFF, and gives a description for turning the flag ON/OFF.
Hardware detects a start and an end of a processing in a program, that is, a position where the flag is to be turned ON/OFF, and gives a description for turning the flag ON/OFF.
A description for a processing of discriminating that the flag is ON and counting the number of times is given at a complier level.
A description for a processing of discriminating that the flag is ON and counting the number of times is given at an OS level.
A description for a processing of discriminating that the flag is ON and counting the number of times is given at a runtime library level.
A description for a processing of discriminating that the flag is ON and counting the number of times is given at a hardware level.
A description for a processing of discriminating that the flag is ON and counting the number of times is given at a tool level.
A description for a processing of discriminating that the flag is ON and counting the number of times is given at an application program level.
A processing of discriminating that the flag is ON and counting the number of times is executed at a hardware level.

(b) Known module names are previously classified into a parallel processing or a processing portion relating to a parallel performance impediment factor, the module names are discriminated at the time of execution, and discrimination of the respective module names are counted to obtain the number of times of the sampling. A classifying method set forth below, a discrimination processing and a count processing are combined as the need arises to measure the processing time.
A classification of module names is made at a complier level.
A classification of module names is made at an OS level.
A classification of module names is made at a runtime library level.
A classification of module names is made at a hardware level.
A classification of module names is made at a parallel language extension or complier directive level.
A classification of module names is made at a user level.
A description for a discrimination processing of the module name and a count processing are given at a complier level.
A description for a discrimination processing of the module name and a count processing are given at an OS level.
A description for a discrimination processing of the module name and a count processing are given at a runtime library level.
A description for a discrimination processing of the module name and a count processing are given at a hardware level.
A description for a discrimination processing of the module name and a count processing are given at a tool level.
A description for a discrimination processing of the module name and a count processing are given at a program level.
A description for a discrimination processing of the module name and a count processing are given at a hardware level.

Returning to the explanation of FIG. 5, the data obtaining unit 10 of the scalability evaluation apparatus 100 obtains respective processing times γᵢ(p) and τᵢ(p) (according to circumstances, also χ_{i,j}(p)), which are measured as a processing time or a sampling count by the measurement unit 201 as described above, from the parallel computer system 200, and stores them into the log data storage 30 connected to the scalability evaluation apparatus 100.

The limit processing time calculator 11 calculates the limit processing time τ_{LT}(p), and stores the limit processing time with the corresponding processing time τ(p) into the scalability limit point judgment data storage 40. Incidentally, the limit processing time τ_{LP}(p) can be calculated even in a case where the load is not balanced, when using the expression (2). On the other hand, in a case where it can be judged that the load is balanced, τ(p)−γⱼ(p) (=χⱼ), which is calculated by using the parallel processing time γⱼ(p) of the processor j whose processing time is τ(p), may be simply used as the limit processing time τ_{LT}(p). When the processing times for all of the parallel performance impediment factors are measured, a result of accumulating all of the processing times for all of the parallel performance impediment factors may be used as the limit processing time τ_{LT}(p).

Furthermore, when resolving the expression (2), the following expressions are obtained.

$$\begin{matrix}{τ}_{LT} ( p ) = \frac{τ ( p )}{{A}_{LT} ( p )} \\ = \frac{τ ( p )}{\frac{1}{1 - {ɛ}_{p} ( p )}} \\ = τ ( p ) ( 1 - {ɛ}_{p} ( p ) ) \\ = τ ( p ) \frac{p τ ( p ) - {\sum }_{i = 1}^{p} {γ}_{i} ( p )}{p τ ( p )} \\ = τ ( p ) - \frac{1}{p} {\sum }_{i = 1}^{p} {γ}_{i} ( p )\end{matrix}$$

The second term indicates an average of the parallel processing times γⱼ(p). The limit processing time τ_{LT}(p) may be calculated according to this expression.

Moreover, the processing content of the scalability processor 12 will be explained in details later.

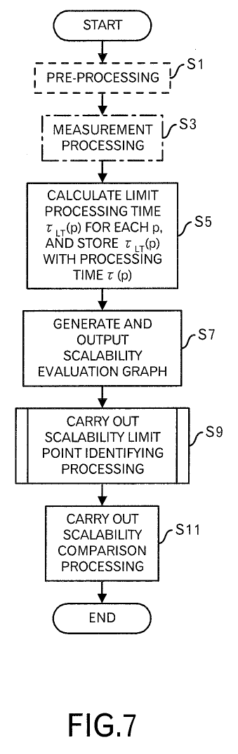

Next, a processing flow of the system or the like explained in FIG. 5 will be described by using FIG. 7. At first, a pre-processing is executed which includes a description for direct measurement of the processing times, a description for turning ON/OFF a flag for counting the number of times of the sampling corresponding to each processing time by a complier, an OS, a tool, a programmer, a runtime library, hardware or the like, and/or a classification of module names and the like for counting the number of times of the sampling corresponding to each processing time by the complier, the OS, the tool, the programmer, the runtime library, the hardware or the like (step S1). There is a case where this processing is performed in the parallel computer system 200 or is performed in another computer system. Further, there is also a case where a person such as a programmer performs it. Incidentally, since the step S1 is not a processing executed in the scalability evaluation apparatus 100 and the step S1 may not be a processing executed in the parallel computer system 200, it is depicted by a block of a dotted line.

Next, the measurement unit 201 of the parallel computer system 200 executes a measurement processing to measure the processing times or a measurement processing to count the number of times of the sampling on the basis of the pre-processing (step S3). The respective processing times γᵢ(p) and τᵢ(p) (according to circumstances, also χ_{i,j}(p)) as measurement results, or count values of the sampling corresponding to the respective processing times are stored into the storage device of the parallel computer system 200, and are read out by the data obtaining unit 10 of the scalability evaluation apparatus 100. When obtaining the respective processing times γᵢ(p) and τᵢ(p) (according to circumstances, also χ_{i,j}(p)) or the count values of the sampling corresponding to the respective processing times, the data obtaining unit 10 stores them into the log data storage 30 of the scalability evaluation apparatus 100. Incidentally, the measurement results with respect to the different numbers p of processors are stored into the log data storage 30. Furthermore, when comparing the parallel computer systems 200 with respect to the scalability, the measurement results of the plural parallel processing systems 200 are stored into the log data storage 30. In addition, because the results are different according to the calculation size even when the configuration of the parallel computer system 200 dose not change, the parallel computer system 200 is treated as being different in the following, when the calculation size is different.

Then, the limit processing time calculator 11 identifies the processing time τ(p) for each number p of processors, for which the measurement result exists, from the respective processing times γᵢ(p) and τᵢ(p) (according to circumstances, also χ_{i,j}(p)) or the count values of the sampling, which respectively correspond to the respective processing time, which are stored in the log data storage 30, and calculates the limit processing time τ_{LT}(p) according to the aforementioned expression, and stores the limit processing time τ_{LT}(p) with the processing time τ(p) into the scalability limit point judgment data storage 40 (step S5). Because the processing time τ(p) is the longest parallel processing time τᵢ(p) as described in the expression (1), the processing time τ(p) can be immediately identified. Incidentally, when processing data concerning the plural parallel computer systems 200, the step S5 is carried out for each parallel computer system.

For example, an example of data stored in the scalability limit point judgment data storage 40 is depicted in FIG. 8. In the example of FIG. 8, the depicted table includes a column of the number p of processors, a column of the processing time τ(p), a column of the limit processing time τ_{LT}(p), a column of Δτ_{LT}(p)/Δτ(p) and a column of a sign of the slope. However, data stored at the step S5 is only data in the columns of the number p of processors and the processing time τ(p). In addition, although data at which the number p of processors is 1 is also represented in the example of FIG. 8, data of p=1 is not always mandatory. Because τ(1) may be a huge value, it may be impossible to measure it. According to this embodiment, τ(1) is not mandatory.

Next, the scalability evaluation graph generator 21 of the scalability processor 12 generates a scalability evaluation graph by using data stored in the scalability limit point judgment data storage 40, and outputs the scalability evaluation graph to the output device 110 (step S7).

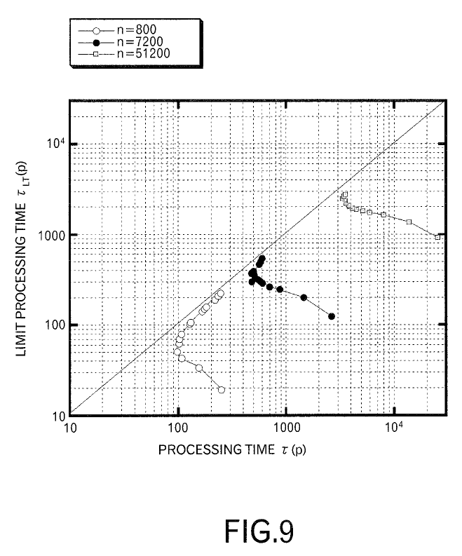

An example of the scalability evaluation graph is depicted in FIG. 9. In the example of FIG. 9, a horizontal axis represents the processing time τ(p), and a vertical axis represents the limit processing time τ_{LT}(p). In such a space, following relations are represented: a change (i.e. a curve) of a relation between the processing time τ(p) and the limit processing time τ_{LT}(p) when the number p of processors is increased with respect to the calculation size n=800 in a certain parallel computer system, a change (i.e. a curve) of the relation between the processing time τ(p) and the limit processing time τ_{LT}(p) when the number p of processors is increased with respect to the calculation size n=7200 and a change (i.e. a curve) of the relation between the processing time τ(p) and the limit processing time τ_{LT}(p) when the number p of processors is increased with respect to the calculation size n=51200. In any cases, in the space, when the number p of processors is small, points representing the aforementioned relations are plotted in the lower right, and when the number p of processors is increased, the points are plotted toward the upper left, and when the number p of processors is increased despite the absence of the scalability, the points are plotted toward the upper right. Incidentally, a 45-degree line, which directs toward the diagonal upper right, is a limit line, and the points representing the relations are not plotted over this limit line to the diagonal upper left area.

In the space as depicted in FIG. 9, the range that it can be said the scalability exists is a portion that the slope of the curve is equal to or less than 0. On the other hand, the range that it can be said that the scalability does not exist is a portion that the slope of the curve is positive. Therefore, the scalability limit point is a switching point from the portion that the scalability exists to the portion that the scalability does not exists. In view of FIG. 9, it is possible to find out the switching point that the slope of the curve changes from negative to positive. That is, it is possible to identify the limit point of the scalability. On the other hand, the larger the negative slope is, the worse the scalability is, and the smaller the negative slope is, the better the scalability is.

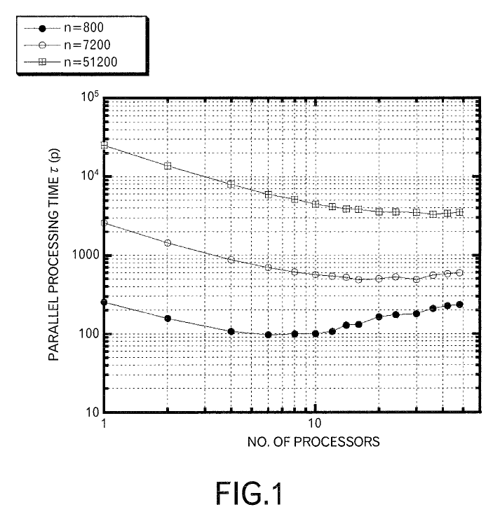

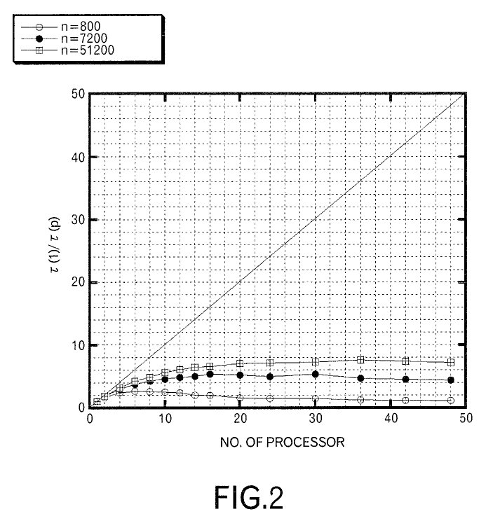

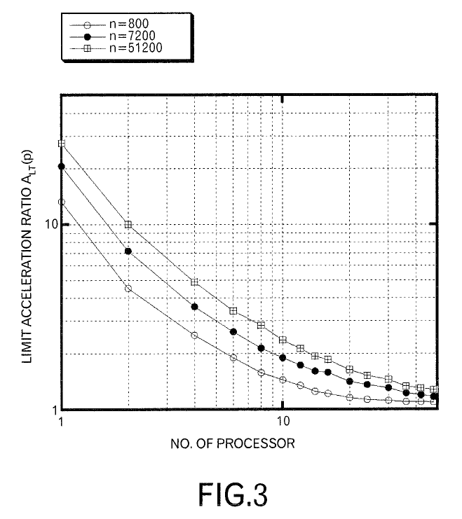

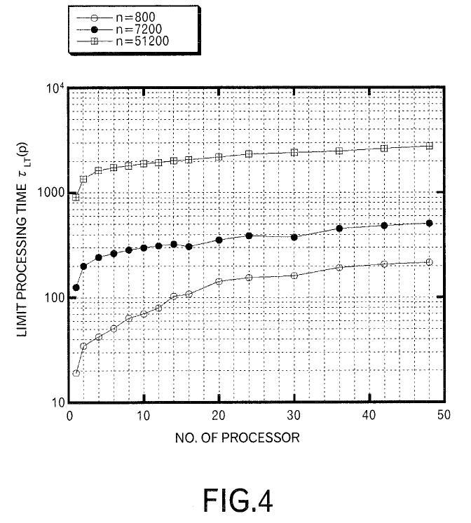

Moreover, FIG. 9 is a diagram corresponding to FIGS. 1 to 4. Namely, the limit point of the scalability, which does not clearly indicate in FIGS. 1 to 4, is clarified. In addition, also in the diagram like FIG. 1, the slope becomes vague and the evaluation of the scalability is also vague when there is no data of τ(1), and the scalability evaluation is difficult because it is impossible to draw the diagram like FIG. 2 when there is no point of τ(1). However, in FIG. 9, even when the point of τ(1) does not exist, it is possible to evaluate the scalability.

Moreover, because this embodiment does not depend on the load division method, this embodiment can be applied to any type of architectures. In addition, because the effect of the load balance is taken into account, this embodiment can be applied to all of the load division methods such as data parallel or control parallel.

Incidentally, when seeing the graph depicted in FIG. 9, it is possible to judge the slope of the curve to some degree. However, when the following processing is carried out, it is possible to indicate the slope of the curve to the user.

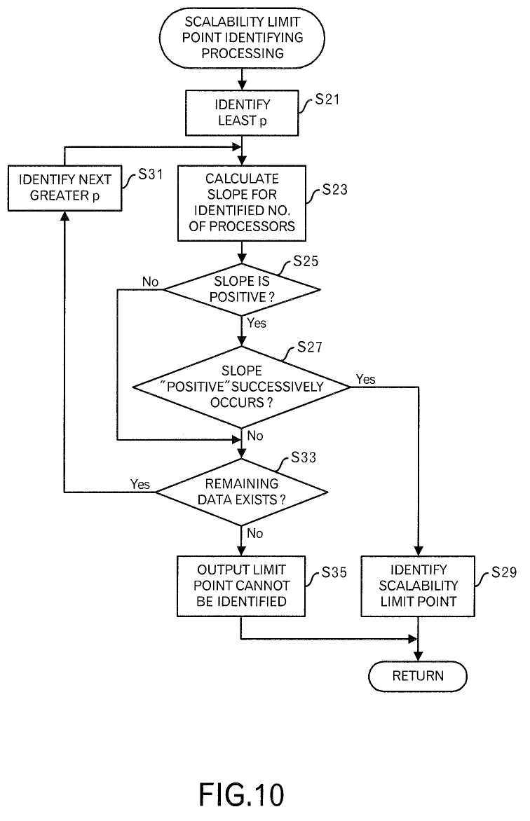

Namely, returning to the explanation of FIG. 7, the scalability limit point judgment unit 22 of the scalability processor 12 carries out a scalability limit point identifying processing (step S9). This scalability limit point identifying processing will be explained by using FIG. 10. Incidentally, the following processing is a processing for one parallel computer system, and when plural parallel computer systems should be treated, the processing depicted in FIG. 10 is carried out plural times.

First, the scalability limit point judgment unit 22 identifies the least number p of processors by using data stored in the scalability limit point judgment data storage 40 (step S21). Then, the scalability limit point judgment unit 22 calculates slope Δτ_{LT}/Δτ for the identified number p of processors, and stores the calculated value into the scalability limit point judgment data storage 40 (the column of Δτ_{LT}/Δτ) (step S23). Specifically, the calculation is carried out according to the following expression.

Δτ_{LT}/Δτ=(τ_{LT}(p+1)−τ_{LT}(p))/(τ(p+1)−τ(p))

Incidentally, because the sign of the slope is used in the following processing, the sign of the slope is also stored into the scalability limit point judgment data storage 40 (i.e. the column of the slope in FIG. 8).

Then, the scalability limit point judgment unit 22 judges whether or not the slope is positive (step S25). When the slope is not positive, the processing shifts to step S33. When the slope is positive, the scalability limit point judgment unit 22 judges whether or not the slope “positive” is successively calculated the predetermined number of times (step S27). This processing is carried out in order not to identify the limit point of the scalability by the measurement errors and the calculation errors, and the predetermined number of times is determined according to occurrence frequency of the measurement errors and the calculation errors. When the slope “positive” is not calculated successively, the scalability limit point judgment unit 22 judges whether or not unprocessed data remains in the scalability limit point judgment data storage 40 (step S33). When the unprocessed data remains, the scalability limit point judgment unit 22 identifies the next greater number p of processors in the scalability limit point judgment data storage 40 (step S31), and the processing returns to the step S23.

On the other hand, when unprocessed data does not remain, namely, data concerning all of the numbers p of processors has been processed, the scalability limit point judgment unit 22 outputs data representing the limit point cannot be identified to the output device 110, and the processing returns to the original processing (step S35). That is, it is understood that it is impossible to identify a portion that the scalability does not exist.

When the slope “positive” successively occurs the predetermined number of times, the scalability limit point judgment unit 22 identifies a scalability limit point by using a value of p or the like before the predetermined number of times (step S29). The identified result is stored, for example, in the scalability limit point judgment data storage 40, and outputted to the output device 110. The output device 110 plots the limit point in such a manner that it can be discriminated from other points, for example, on the scalability evaluation graph. For example, it is emphasized by a different color or is displayed with the blinks.

The processing of the step S29 uses the number p of processors before the predetermined number of times, simply. For example, “2” is set to the predetermined number of times, and at p=14, the slope changes to positive in FIG. 8, and at p=16, the processing shifts to the step S29. In this case, the scalability limit point is identified as p=12 and τ(p)=539.20, which were identified before twice.

On the other hand, the number p of processors, at which the slope becomes 0, may be calculated by the interpolation. In the example of FIG. 8, the following calculation is carried out because the slope is changed at p=12 and p=14.

$$\begin{matrix}P = 0.54463 / ( 0.54463 + 0.47531 ) * ( 14 - 12 ) + 12 \\ = 13.1 \approx 13 \\ τ ( p ) = 0.54463 / ( 0.54463 + 0.47531 ) * ( 519.57 - 539.20 ) + 539.20 \\ = 528.70\end{matrix}$$

Such a simple method may be adopted or the point at which the slope becomes 0 may be actually identified by the interpolation. By carrying out such a processing, it becomes possible to analytically calculate the scalability limit point and present it for the user. Incidentally, the processing returns to the original processing after the step S29.

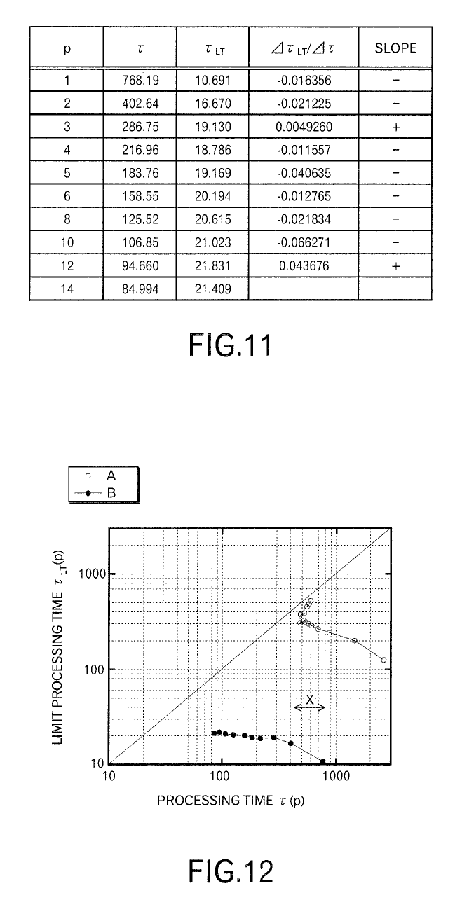

Returning to the explanation of FIG. 7, when comparing the plural parallel computer systems 200 with respect to the scalability, the scalability comparison unit 23 of the scalability processor 12 carries out a scalability comparison processing by using data stored in the scalability limit point judgment data storage 40 (step S11). In such a case, for example, it is assumed that, in addition to the data as depicted in FIG. 8, data as depicted, for example in FIG. 11 is also stored in the scalability limit point judgment data storage 40.

In the example of FIG. 11, the slope temporarily becomes positive at p=3 because of the measurement errors and/or the calculation errors. However, because the slope “positive” does not successively occur, the scalability limit point is not identified at p=3. In addition, the slope becomes “positive” at p=12 again. However, because it does not successively occur the predetermined times, the scalability limit point is not also identified at p=12.

Incidentally, when representing FIGS. 8 and 11 by the scalability evaluation graph, FIG. 12 is obtained. Thus, when the parallel computer system A (FIG. 8) is compared with the parallel computer system B (FIG. 11), a portion X in which τ(p) overlaps exists. Because both of the slopes are negative in this portion X, this is a portion the scalability exists.

In the scalability comparison processing, the limit processing times τ_{LT}(p) at the same τ(p) within the portion the scalability exists is compared. In the example of FIGS. 8 and 11, the limit processing time τ_{LT}(p) of one parallel computer system is calculated by extrapolation on a basis of the other parallel computer system.

For example, when the parallel computer system B is a reference, the extrapolation is carried out for the parallel computer system A. When the parallel computer system B is a reference, τ(1)=768.19 and τ_{LT}(1)=10.691 are used as a reference point in the portion X. The point of the parallel computer system A near τ=768.19 is represented by τ(6)=693.09 and τ_{LT}(6)=264.59, and Δτ_{LT}/Δτ=−0.25225 is used. Then, τ_{LT}=246 (=−0.25225*(768.19−693.09)+264.59). Namely, the scalability of the parallel computer system B is 23 times (=246/10691) as good as the scalability of the parallel computer system A as a ratio of the limit processing time τ_{LT}. Thus, the short limit processing time is better.

On the other hand, it is possible to use the parallel computer system A as a reference. In such a case, by using τ(6)=693.09 and τ_{LT}(6)=264.59 as a reference, a point, which is represented by τ(1)=768.19 and τ_{LT}(6)=10.691 and is near τ(6)=693.09, is used. At that time, Δτ_{LT}/Δτ=−0.016356. Then, τ_{LT} at τ=693.09 is calculated as follows:

τ_{LT}=−0.016356*(693.09−768.19)+10.691=11.9

Therefore, at τ=693.09, the scalability of the parallel computer system B is 22 time (=264.59/11.9) as good as the scalability of the parallel computer system A as a ratio of the limit processing time τ_{LT}.

Thus, the scalability comparison can be quantitatively carried out.

Although the embodiment of this invention was explained, this invention is not limited to this embodiment. For example, the functional block diagram of FIG. 5 is a mere example, and does not always correspond to a program module configuration. In addition, processing units such as the scalability limit point judgment unit 22 and the scalability comparison unit 23 may not be provided. As for the processing flow, when the same result can be obtained, the order of the processing step may be exchanged and may be executed in parallel.

What is claimed is:

1. A data processing method for scalability of a parallel computer system, said data processing method comprising:
obtaining a processing time τ(p) that is a longest processing time in a case where a parallel processing is carried out by p processors and a processing time γᵢ(p) (i represents a processor number) that is a processing time of parallel calculation portions during an executed processing;
calculating a limit processing time τ_{LT}(p) that is an entire processing time in assuming that said processing time of said parallel calculation portions has become zero, by using said processing time τ(p) and said processing time γᵢ(p) of said parallel calculation portions; and
outputting a relation between said processing time τ(p) and said limit processing time τ_{LT}(p) with respect to said number p of processors to an output device.

2. The data processing method as set forth in claim 1, wherein said outputting comprises generating a graph in a space mapped by an axis of said processing time τ(p) and an axis of said limit processing time τ_{LT}(p), and outputting the generated graph.

3. The data processing method as set forth in claim 1, wherein said outputting comprises identifying, as a limit point, a number p₁ of processors in a case where a ratio of a variation of said limit processing time τ_{LT}(p) to a variation of said processing time τ(p) changes from negative to positive along with increase of said number of processors, and outputting the identified number p₁ of processors.

4. The data processing method as set forth in claim 3, wherein said identifying comprises identifying, as said limit point, said number τ₁ of processors immediately before said ratio changes from negative to positive.

5. The data processing method as set forth in claim 1, further comprising:
carrying out said obtaining, said calculating and said outputting for a second parallel computer system;
identifying a first limit processing time τ_{LT1}(p) in said parallel computer system and a second limit processing time τ_{LT2}(p) in said second parallel computer system, whose corresponding processing times τ(p) are identical each other in said parallel computer system and said second parallel computer system; and
calculating a second ratio of said first limit processing time τ_{LT1}(p) and said second limit processing time τ_{LT2}(p), and outputting said second ratio to said output device.

6. The data processing method as set forth in claim 1, wherein said calculating said limit processing time comprises:
identifying a processing time γⱼ(p) of said parallel calculation portions of a processor j that required said processing time τ(p); and
identifying, as said limit processing time τ_{LT}(p), a difference between said processing time τ(p) and said processing time γⱼ(p) of said parallel calculation portions.

7. The data processing method as set forth in claim 1, wherein said calculating said limit processing time comprises:
calculating an average of said processing times γᵢ(p) of said parallel calculation portions; and
identifying, as said limit processing time τ_{LT}(p), a difference between said processing time τ(p) and said average of said processing times γᵢ(p) of said parallel calculation portions.

8. The data processing method as set forth in claim 1, further comprising measuring, in said parallel computer system, a processing time γᵢ(p) of said parallel calculation portions and a processing time τᵢ(p) in each processor.

9. A computer-readable storage medium storing a program for causing a computer to execute a process for scalability of a parallel computer system, said process comprising:
obtaining a processing time τ(p) that is a longest processing time in a case where a parallel processing is carried out by p processors and a processing time γᵢ(p) (i represents a processor number) that is a processing time of parallel calculation portions during an executed processing;
calculating a limit processing time τ_{LT}(p) that is an entire processing time in assuming that said processing time of said parallel calculation portions has become zero, by using said processing time τ(p) and said processing time γᵢ(p) of said parallel calculation portions; and
outputting a relation between said processing time τ(p) and said limit processing time τ_{LT}(p) with respect to said number p of processors to an output device.

10. A data processing apparatus for scalability of a parallel computer system, said data processing apparatus comprising:
a data storage device storing a processing time τ(p) that is a longest processing time in a case where a parallel processing is carried out by p processors and a processing time γᵢ(p) (i represents a processor number) that is a processing time of parallel calculation portions during an executed processing;
a unit that calculates a limit processing time τ_{LT}(p) that is an entire processing time in assuming that said processing time of said parallel calculation portions has become zero, by using said processing time τ(p) and said processing time γᵢ(p) of said parallel calculation portions, which are stored in said data storage device; and
a unit that outputs a relation between said processing time τ(p) and said limit processing time τ_{LT}(p) with respect to said number p of processors to an output device.
